(19) United States
(12) Patent Application Publication
(10) Pub. No.: US 2005/0226162 A1
(43) Pub. Date: Oct. 13, 2005

(54) Methods, systems, and products for maintaining communications service reachability

(76) Inventors: Edgar Vaughan Shrum JR., Smyrna, GA (US); Eric Charles Schwartz, Smyrna, GA (US)

Correspondence Address: Scott P. Zimmerman, P.O. Box 3822, Cary, NC, 27519, US

(21) Appl. No.: 10/813,491

(22) Filed: Mar. 30, 2004

(51) Int. Cl. H04L 12/66

(52) U.S. Cl. 370/241

(57) ABSTRACT

Methods, systems, and products are disclosed for providing communications services. One method determines a state of an Internet Protocol communications device. The method then reconfigures call routing information based upon the state of the Internet Protocol communications device.

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### BACKGROUND OF THE INVENTION

1. Field of the Invention

This invention generally relates to electrical computers, telecommunications, telephonic communications, electrical communications and, more particularly, to call routing information.

2. Description of the Related Art

Voice-Over Internet Protocol networks assume an end device is available. That is, once an end device (such as a computer, phone, or other Internet Protocol communications device) registers and authenticates with the Voice-Over Internet Protocol communications network, the intelligence controlling the network assumes the end device is available. A Session Initiation Protocol (SIP) phone, for example, periodically registers and indicates its availability to the Voice-Over Internet Protocol communications network. This availability allows messages and other data to originate, and to terminate, from the SIP phone. The Voice-Over Internet Protocol communications network continues to assume the end device is available until a new registration occurs.

A recurring problem, however, is that connectivity is often lost. The term “connectivity” describes the existence of a signaling path to the end device. That is, the Voice-Over Internet Protocol communications network and the end device trade/pass signaling messages. When connectivity is lost, the Voice-Over Internet Protocol communications network currently has no proactive method of knowing that the signaling path is lost. Because the Voice-Over Internet Protocol communications network assumes the end device is available, data is passed to the end device, even though connectivity is lost. The Voice-Over Internet Protocol communications network, in fact, will send data, despite the lost connectivity, until a new registration occurs or until a communication request has failed/timed out. Computing resources are thus wasted on erroneous connectivity data, and the calling party experience is poor. There is, accordingly, a need in the art for methods and systems of monitoring the connectivity status of an end device. When connectivity is lost, a need exists for alternatively routing communications to the end device to determine the best mode of still reaching the subscriber.

### BRIEF SUMMARY OF THE INVENTION

The aforementioned problems, and other problems, are reduced by this invention. This invention comprises methods, computer systems, computer programs, and computer program products that provide communications services. This invention, in particular, proactively monitors the state of Internet Protocol communications devices. This invention then uses the state of the Internet Protocol communications device to determine the best mode to reach a subscriber. This invention, then, not only determines reachability information, but this invention also intelligently routes communications to further ensure the subscriber is contacted. The subscriber's perception of their communications service is improved, and this invention also improves the actual service availability.

This invention includes a software product termed a “Communications Module.” This Communications Module proactively monitors the state of the subscriber's Internet Protocol communications device. The Communications Module then uses this state determination to originate, and to terminate, communications (any data messages, including Internet Protocol telephone calls), even if the subscriber's IP communications device is unavailable. The Communications Module periodically polls the subscriber's Internet Protocol communications device and resets a timer. If connectivity is lost, the Communications Module fails to receive a response from the subscriber's IP communications device. The Communications Module then accesses and executes a variety of call processing and call control logic to reconfigure the underlying communications service. If connectivity is established, but a subsequent communication is refused or not accepted, the Communications Module again accesses and executes a variety of call processing and call control logic to reconfigure the underlying communications service.

This invention discloses methods, systems, and products for providing communications services. One of the embodiments determines a state of an Internet Protocol communications device. The method then reconfigures call routing information based upon the state of the Internet Protocol communications device. The Voice-Over Internet Protocol communications network is thus proactively reconfigured based upon the state of the Internet Protocol communications device.

Another of the embodiments describes another method for providing communications services. Here an Internet Protocol communications device is polled to determine if a signaling path exists with a Voice-Over Internet Protocol communications network. If the signaling path fails to exist, then call routing information is reconfigured based upon at least one of i) network-defined logic and ii) subscriber-defined logic. This embodiment proactively reconfigures the call routing information based upon an availability of the Internet Protocol communications device.

Yet another of the embodiments describes still another method for providing communications services. An Internet Protocol communications device is polled to determine if a signaling path exists in a Voice-Over Internet Protocol communications network. If a response is not received within a specified time, then the call routing information is reconfigured based upon at least one of i) the network-defined logic and ii) the subscriber-defined logic. The call routing information is thus proactively reconfigured based upon an availability of the Internet Protocol communications device.

Other embodiments of this invention describe a system for providing communications services. A Communications Module is stored in a memory device, and a processor communicates with the memory device. The Communications Module determines a state of an Internet Protocol communications device and reconfigures call routing information based upon the state of the Internet Protocol communications device.

Still other embodiments of this invention describe a computer program product. A computer-readable medium stores a Communications Module. The Communications Module determines a state of an Internet Protocol communications device and reconfigures call routing information based upon the state of the Internet Protocol communications device.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE SEVERAL VIEWS OF THE DRAWINGS

These and other features, aspects, and advantages of the embodiments of the present invention are better understood when the following Detailed Description of the Invention is read with reference to the accompanying drawings, wherein:

FIGS. 1 & 2 are schematics illustrating the embodiments of this invention;

FIG. 3 depicts another possible operating environment for the embodiments of this invention;

FIGS. 4 and 5 illustrate yet other possible operating environments for the embodiments of this invention;

FIG. 6 is a schematic illustrating various Internet Protocol communications devices 22 that operate with this invention;

FIG. 7 is a flowchart illustrating a method of providing communications services, according to even more embodiments of this invention; and

FIG. 8 is a flowchart illustrating still another method of providing communications services, according to even more embodiments of this invention.

### DETAILED DESCRIPTION OF THE INVENTION

This invention now will be described more fully hereinafter with reference to the accompanying drawings, in which exemplary embodiments are shown. This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named manufacturer.

This invention determines the best mode to reach a subscriber. This invention determines reachability information and also intelligently routes communications to further ensure the subscriber is contacted. This invention, then, improves the subscriber's perception of their communications service, and this invention also improves the actual service availability. A software Communications Module proactively monitors the state of the subscriber's Internet Protocol communications device. The Communications Module then uses this state determination to originate, and to terminate, communications (any data messages, including Internet Protocol telephone calls), even if the subscriber's IP communications device is unavailable. The Communications Module periodically polls the subscriber's Internet Protocol communications device and resets a timer. If connectivity is lost, the Communications Module fails to receive a response from the subscriber's IP communications device. The Communications Module then accesses and executes a variety of call processing and call control logic to reconfigure the underlying communications service.

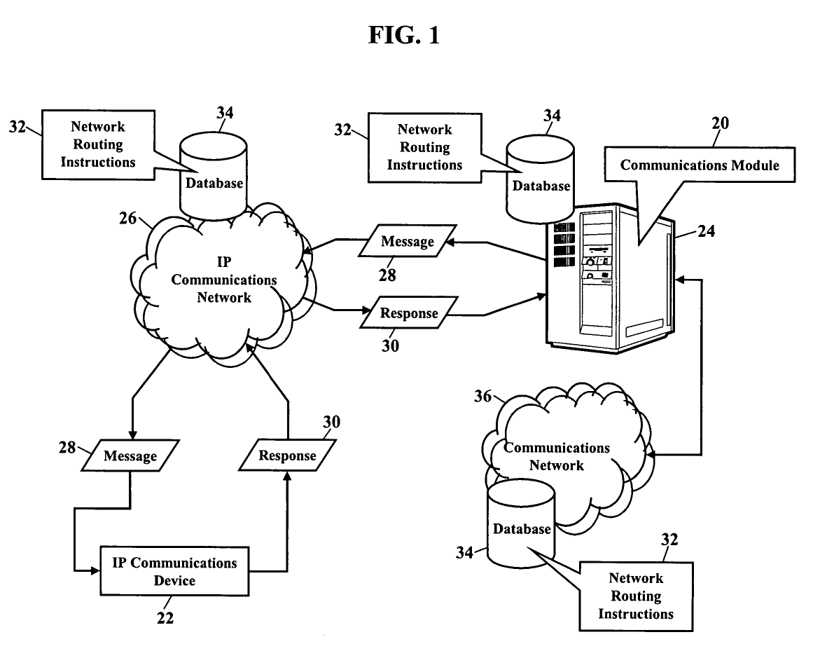

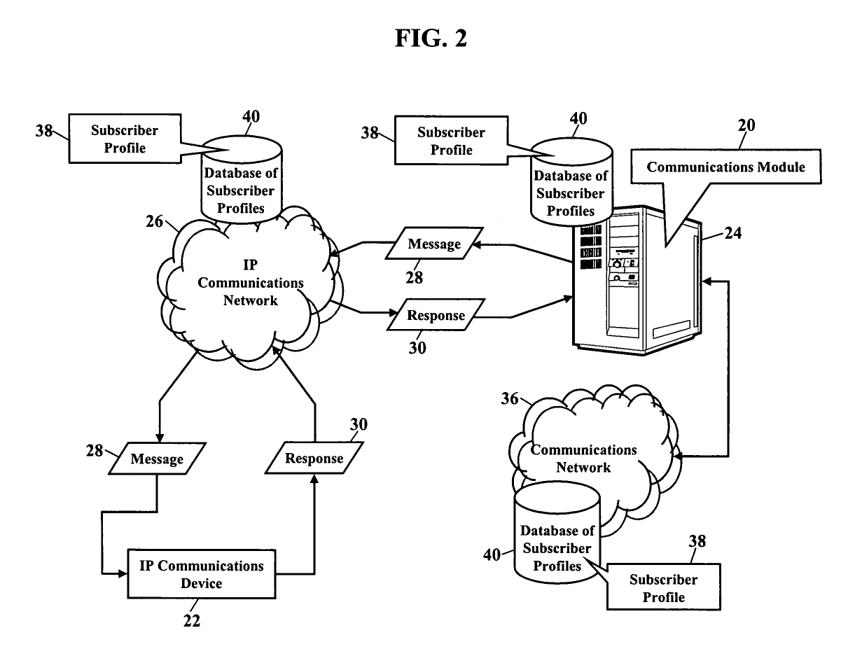

FIGS. 1 & 2 are schematics illustrating the embodiments of this invention. The embodiments of this invention include a Communications Module 20. The Communications Module 20 comprises methods, systems, computer programs, and/or computer program products that proactively monitor the state of an Internet Protocol (IP) communications device 22. The Communications Module 20 operates within any computer system, such as a communications server 24. The Communications Module 20 attempts to communicate with the Internet Protocol communications device 22 via an Internet Protocol communications network 26 (shown as “IP Communications Network”). The Communications Module 20 then determines a state of the Internet Protocol communications device 22 and reconfigures call routing information based upon that state.

The Communications Module 20 proactively reconfigures call routing information. The Communications Module 20 determines the state of the Internet Protocol communications device 22. Once the state is known, the Communications Module 20 takes actions based upon that state. One such state is a “Not Available” (or “No Connection”) state. The “Not Available” state means the Communications Module 20 is unable to establish/set-up a signaling path/link with the Internet Protocol communications device 22. That is, the “Not Available” state means the Communications Module 20 cannot communicate with the Internet Protocol communications device 22. As the following paragraphs explain, when the “Not Available” state is determined, the Communications Module 20 proactively reconfigures the call routing information and alternatively routes communications intended for the Internet Protocol communications device 22. Once the call routing information has been altered (based on determining the “not available” state), the call routing information could once again be altered when the Communications Module 20 detects that the Internet Protocol communications device 22 is back on line (e.g., power has been restored and/or re-registration occurs).

FIG. 1 illustrates an availability determination. Here the Communications Module 20 periodically polls the Internet Protocol communications device 22 to determine state. The Communications Module 20 periodically generates a message 28 to check/survey the state of the Internet Protocol communications device 22. The message 28 is addressed to the Internet Protocol communications device 22. The message 28 communicates via the Internet Protocol communications network 26. If the message 28 is received by the Internet Protocol communications device 22, the Internet Protocol communications device 22 then return communicates a response 30. This response 30 communicates from the Internet Protocol communications device 22 to the Communications Module 20 via the Internet Protocol communications network 26. Because the response 30 is received by the Communications Module 20, the Communications Module 20 knows the Internet Protocol communications device 22 has an “Available” state. That is, the “Available” state implies a signaling path is available between the Communications Module 20 and the Internet Protocol communications device 22. The Communications Module 20 thus knows the Internet Protocol communications device 22 is ready and able to further receive Internet Protocol communications.

The Internet Protocol communications device 22, however, may not be available. When the Communications Module 20 addresses the message 28 to the Internet Protocol communications device 22, the message 28 is sent via the Internet Protocol communications network 26. If the Internet Protocol communications device 22 fails to return the response 30, then the Communications Module 20 knows the Internet Protocol communications device 22 has the “Not Available” state. The “Not Available” state means the Communications Module 20 is unable to communicate with the Internet Protocol communications device 22. The “Not Available” state, for example, may indicate the Internet Protocol communications device 22 is not powered to receive the message 28. The “Not Available” state could also indicate the Internet Protocol communications device 22 is beyond the range of a wireless antenna/network and/or that the Internet Protocol communications device 22 is malfunctioning.

The “Not Available” state could also indicate a “network trouble” condition. The Communications Module 20 addresses the message 28 to the Internet Protocol communications device 22. The message 28 is received via the Internet Protocol communications network 26, and the Internet Protocol communications device 22 returns the response 30. This response 30, however, “times out.” That is, the response 30 is received, but the response 30 is late. The late response 30 may indicate some malfunction, a congested communications path, and/or any other “network trouble” condition that prevents/hinders communication with the Internet Protocol communications device 22. An example of this “network trouble” condition could be a congested state of the network. Because the Communications Manager 20 utilizes a timer, this timer may be used to determine a congested state of the network. For example, if the response 30 consistently (e.g., 3 consecutive pings) takes more than one hundred milliseconds (100 ms), then the Communications Manager 20 may assume the intermediate network is congested and that voice quality is poor. The Communications Manager 20, based on that determination, may re-route in-coming calls to an alternative device.

When the “Not Available” state is determined, reconfiguration occurs. If the Communications Module 20 fails to receive the response 30, and/or the response 30 is late, then the Communications Module 20 assumes the “Not Available” state. Because the Communications Module 20 cannot establish a signaling path, the Communications Module 20 proactively reconfigures the call routing information. That is, until the periodically-generated message 28 prompts a timely receipt of the response 30, any communications addressed to the Internet Protocol communications device 22 are rerouted. Alternate call routing instructions may be specified by at least one of i) network-defined logic and ii) subscriber-defined logic. As FIG. 1 shows, the Communications Module 20 may access network routing instructions 32. The network routing instructions 32 contain network-defined logical instructions for rerouting communications in the “Not Available” state. These network-defined logical instructions specify alternate routing destinations when any Internet Protocol communications device (such as that shown as reference numeral 22) has the “Not Available” state. These network-defined logical instructions 32, for example, may specify that any further communications are automatically rerouted (or readdressed) to a subscriber's email address, a subscriber's home IP phone, a cellular phone, an archival storage server, and/or any other alternate destination the service provider might desire. The network routing instructions 32 are stored/maintained in a database 34. The database 34 may be collocated to the communications server 24. The database 34, however, may additionally or alternatively be remotely located and communicating with the Communications Module 20 via the Voice-Over Internet Protocol communications network 26 and/or a separate, and perhaps secure, communications network 36 (e.g., distributed computing network, intranet, Local Area Network, Wide Area Network).

The subscriber may also specify routing instructions. As FIG. 2 shows, the Communications Module 20 may additionally or alternatively access a subscriber profile 38. The subscriber profile 38 contains subscriber-defined logical instructions for rerouting communications in the “Not Available” state. These subscriber-defined logical instructions 38, for example, may specify that communications are automatically rerouted (or readdressed) to the subscriber's email address, the subscriber's alternate Internet Protocol communications device, the subscriber's vehicle, an archival storage server, a cellular/wireless device, and/or any other destination the subscriber might desire. The subscriber may specify alternate destinations based upon a time of day, a day of week, entries in a calendar, and/or whatever other rules/logic the subscriber may implement. As FIG. 2 also shows, the subscriber profile 38 is stored/maintained in a database 40 of subscriber profiles. The database 40 of subscriber profiles may be collocated to the communications server 24. The database 40 of subscriber profiles, however, may additionally or alternatively be remotely located and communicating with the Communications Module 20 via the Voice-Over Internet Protocol communications network 26 and/or the communications network 36.

The Communications Module 20 periodically polls to determine availability. The Communications Module 20, as earlier mentioned, periodically generates the message 28. The periodicity of the generated message 28 may be any interval from seconds to hours. The periodicity, however, is preferably shorter than any interval for registration messages. (If the periodicity is greater than, or equal to, the interval for registration messages, then polling serves a lesser purpose.) If, for example, the periodicity is sixty (60) seconds, the Communications Module 20 polls the Internet Protocol communications device 22 every minute to determine availability. If the Internet Protocol communications device 22 return communicates the response 30, the Internet Protocol communications device 22 has the “Available” state and is ready and able to further receive Internet Protocol communications. If, however, the Communications Module 20 fails to receive the response 30, then the Internet Protocol communications device 22 has the “Not Available” state. The “Not Available” state means the Communications Module 20 preferably does not route communications to the Internet Protocol communications device 22. After the message 28 is generated, the Communications Module 20 then resets a timer. At the next interval, when a subsequent message 28 is generated, the Communications Module 20 re-evaluates the availability of the Internet Protocol communications device 22. Further, a registration message received from the Internet Protocol communications device 22 starts this initial cycling of polling messages. In this manner network resources are not wasted once the once the Internet Protocol communications device 22 has been determined to no longer be available.

The Communications Module 20 utilizes a messaging protocol. When the Communications Module 20 initiates the message 28, the Communications Module 20 may use any messaging protocol. Those of ordinary skill in the art of computer networking understand that many protocols exist and that new protocols are constantly being developed and proposed. One of the more familiar messaging protocols is the “Session Initiation Protocol” (or “SIP”) for initiating an interactive user session that involves multimedia elements such as video, voice, chat, gaming, and virtual reality. Other messaging protocols include the “Simple Management Protocol” (or “SMP”) and the “Simple Network Management Protocol (SNMP) for managing complex networks by sending messages to different components/parts of a network. A more recently proposed protocol is the “Instant Messaging and Presence Protocol” (or “IMPP”) for passing messages among the different users/systems while retaining encryption, integrity protection, and a shared framework for presence information. Another recent protocol is the “Extensible Messaging and Presence Protocol” (or “XMPP”), an open, XML-based protocol for near real-time extensible messaging and presence information. Yet another protocol is the “Internet Control Message Protocol” (or “ICMP”), an extension to the Internet Protocol (IP), for supporting packets containing error, control, and informational messages (such as the PING command to test an Internet connection). There are also many other protocols for transport of data between network nodes. Those of ordinary skill in the art also understand that the number of protocols is too numerous to list, yet the Communications Module 20 may use any messaging protocol.

As FIGS. 1 & 2 show, this invention determines the best mode to reach the subscriber. This invention not only determines reachability information but, also, intelligently routes communications to further ensure the subscriber is contacted. This invention, then, improves the subscriber's perception of their communications service, and this invention also improves the actual service availability. The Communications Module 20 proactively monitors the state of the subscriber's Internet Protocol communications device 22 to originate, and to terminate, Internet Protocol telephone calls (and other communications) even though an end point is unavailable. The Communications Module 20 periodically polls the subscriber's Internet Protocol communications device 22 and resets a timer. If connectivity is lost, then the Communications Module 20 fails to receive the response 30. The Communications Module 20 then accesses and executes a variety of call processing and call control logic to reconfigure the underlying communications service. Once the call routing information has been altered, the call routing information could once again be altered when the Communications Module 20 detects that the Internet Protocol communications device 22 is back on line (e.g., power has been restored and/or re-registration occurs).

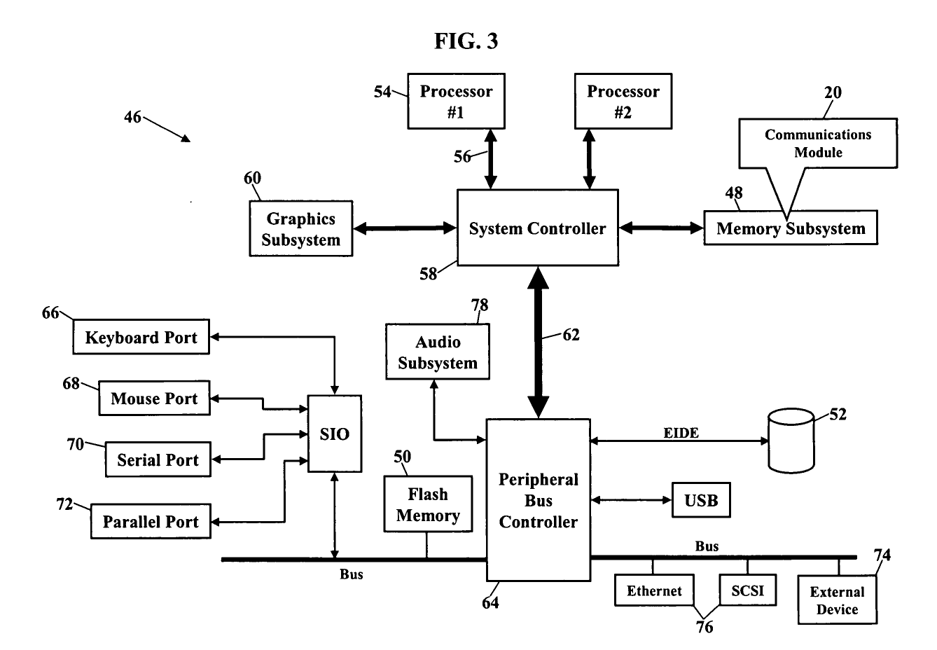

FIG. 3 depicts another possible operating environment for the embodiments of this invention. FIG. 3 is a block diagram showing the Communications Module 20 residing in a computer system 46. The computer system 46 may be any computing system, such as the communications server (shown as reference numeral 24 in FIGS. 1-3) or any other computer device. As FIG. 3 shows, the Communications Module 20 operates within a system memory device. The Communications Module 20, for example, is shown residing in a memory subsystem 48. The Communications Module 20, however, could also reside in flash memory 50 or a peripheral storage device 52. The computer system 46 also has one or more central processors 54 executing an operating system. The operating system, as is well known, has a set of instructions that control the internal functions of the computer system 46. A system bus 56 communicates signals, such as data signals, control signals, and address signals, between the central processor 54 and a system controller 58 (typically called a “Northbridge”). The system controller 58 provides a bridging function between the one or more central processors 54, a graphics subsystem 60, the memory subsystem 48, and a PCI (Peripheral Controller Interface) bus 62. The PCI bus 62 is controlled by a Peripheral Bus Controller 64. The Peripheral Bus Controller 64 (typically called a “Southbridge”) is an integrated circuit that serves as an input/output hub for various peripheral ports. These peripheral ports are shown including a keyboard port 66, a mouse port 68, a serial port 70 and/or a parallel port 72 for a video display unit, one or more external device ports 74, and networking ports 76 (such as SCSI or Ethernet). The Peripheral Bus Controller 58 also includes an audio subsystem 78. Those of ordinary skill in the art understand that the program, processes, methods, and systems described in this patent are not limited to any particular computer system or computer hardware.

Those of ordinary skill in the art also understand the central processor 54 is typically a microprocessor. Advanced Micro Devices, Inc., for example, manufactures a full line of ATHLON™ microprocessors (ATHLON™ is a trademark of Advanced Micro Devices, Inc., One AMD Place, P.O. Box 3453, Sunnyvale, Calif. 94088-3453, 408.732.2400, 800.538.8450, www.amd.com). The Intel Corporation also manufactures a family of X86 and P86 microprocessors (Intel Corporation, 2200 Mission College Blvd., Santa Clara, Calif. 95052-8119, 408.765.8080, www.intel.com). Other manufacturers also offer microprocessors. Such other manufacturers include Motorola, Inc. (1303 East Algonquin Road, P.O. Box A3309 Schaumburg, Ill. 60196, www.Motorola.com), International Business Machines Corp. (New Orchard Road, Armonk, N.Y. 10504, (914) 499-1900, www.ibm.com), and Transmeta Corp. (3940 Freedom Circle, Santa Clara, Calif. 95054, www.transmeta.com). Those skilled in the art further understand that the program, processes, methods, and systems described in this patent are not limited to any particular manufacturer's central processor.

The preferred operating system is the UNIX® operating system (UNIX® is a registered trademark of the Open Source Group, www.opensource.org). Other UNIX-based operating systems, however, are also suitable, such as LINUX® or a RED HAT® LINUX-based system (LINUX® is a registered trademark of Linus Torvalds, and RED HAT® is a registered trademark of Red Hat, Inc., Research Triangle Park, North Carolina, 1-888-733-4281, www.redhat.com). Other operating systems, however, are also suitable. Such other operating systems would include a WINDOWS-based operating system (WINDOWS® is a registered trademark of Microsoft Corporation, One Microsoft Way, Redmond Wash. 98052-6399, 425.882.8080, www.Microsoft.com). and Mac® OS (Mac® is a registered trademark of Apple Computer, Inc., 1 Infinite Loop, Cupertino, Calif. 95014, 408.996.1010, www.apple.com). Those of ordinary skill in the art again understand that the program, processes, methods, and systems described in this patent are not limited to any particular operating system.

The system memory device (shown as memory subsystem 48, flash memory 50, or peripheral storage device 52) may also contain an application program. The application program cooperates with the operating system and with a video display unit (via the serial port 70 and/or the parallel port 72) to provide a Graphical User Interface (GUI). The Graphical User Interface typically includes a combination of signals communicated along the keyboard port 66 and the mouse port 68. The Graphical User Interface provides a convenient visual and/or audible interface with a user of the computer system 46.

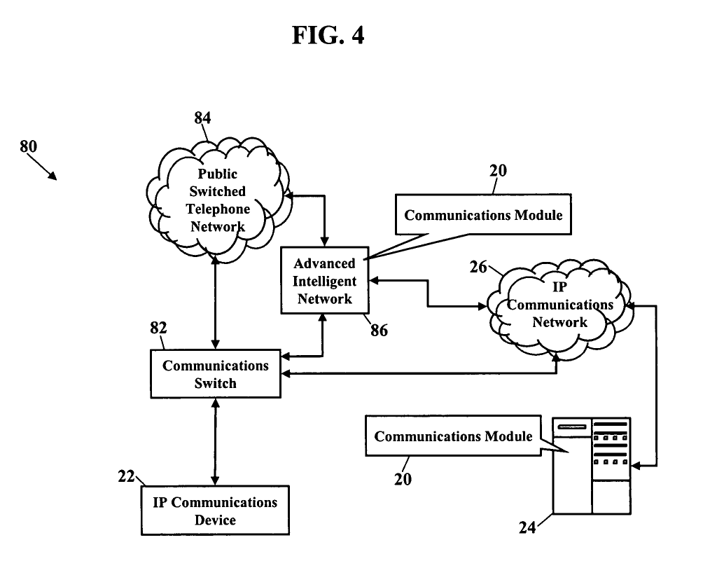

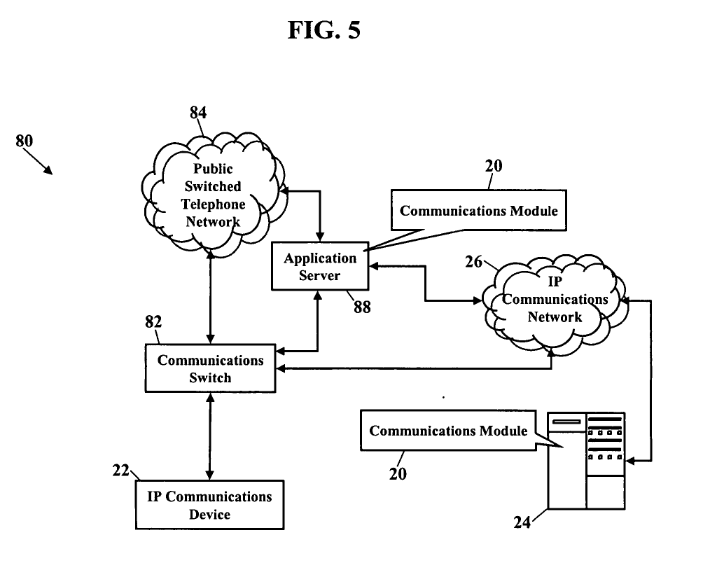

FIGS. 4 and 5 illustrate yet other possible operating environments for the embodiments of this invention. FIG. 4 is a schematic showing the Communications Module 20 operating within an intelligently-controlled communications network 80. This communications network 80 further represents an operating environment for the Communications Module 20. The communications network 80 includes a communications switch 82 of a Public Switched Telephone Network 84. The communications switch 82 includes Advanced Intelligent Network (AIN) componentry 86 controlling many features of the communications switch 82. The Advanced Intelligent Network (AIN) componentry 86 includes the Communications Module 20 operating within the computer system (shown as reference numeral 46 in FIG. 4). The communications switch 82 and the Advanced Intelligent Network (AIN) componentry 86 interfaces with the Voice-Over Internet Protocol communications network 26. The Voice-Over Internet Protocol communications network 26 may also communicate with the communications server 24, and the Communications Module 20 resides within the communications server 24. The signaling between the communications switch 82, the Public Switched Telephone Network 84, the Advanced Intelligent Network 86, and the Voice-Over Internet Protocol communications network 26, however, is well understood in the art and will not be further described. If a reader desires a more detailed explanation, the reader is directed to U.S. Pat. No. 5,430,719 issued to Weisser (Jul. 4, 1995), with the “Summary of the Invention” and the “Detailed Description of the Preferred Embodiment” sections incorporated herein by reference. The reader is also directed to U.S. Pat. No. 5,917,817 issued to Dunn et al. (Jun. 29, 1999), with the “Summary of the Invention” and the “Detailed Description” sections incorporated herein by reference.

FIG. 5 is similar to FIG. 4, yet FIG. 5 illustrates a packet-network architecture. This packet network represents an alternative operating environment for the Communications Module 20. Here the communications switch 82 is a packet-based “softswitch.” This softswitch uses software control to provide voice, data, and video services by dynamically changing its connection data rates and protocols types. An application server 88 interfaces with the softswitch via a packet protocol, such as Session Initiation Protocol (SIP). This application server 88 includes voice service protocols, triggers, and/or operations that allow the Public Switched Telephone Network 84 and the Voice-Over Internet Protocol communications network 26 to interoperate.

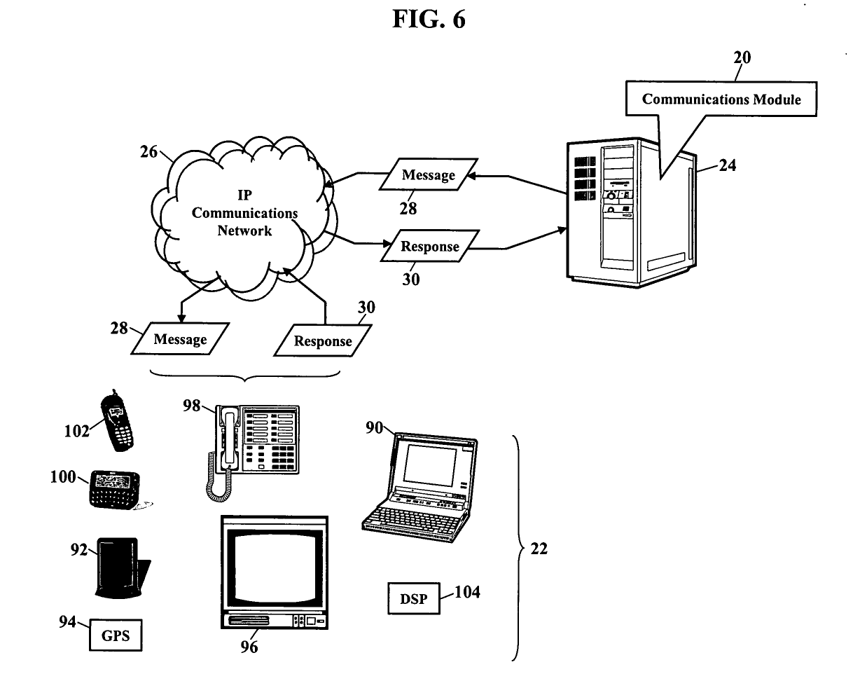

FIG. 6 is a schematic illustrating various Internet Protocol communications devices 22 that operate with this invention. This invention comprises methods, systems, computer programs, and/or computer program products that proactively monitor the state of the Internet Protocol communications device 22. As FIG. 6 shows, the Communications Module 20 may proactively monitor the state of a computer 90 (laptop, desktop, tablet, server, and other computer systems), a personal digital assistant (PDA) 92, a Global Positioning System (GPS) device 94, an interactive television 96, an Internet Protocol (IP) phone 98, a pager 100, a cellular/satellite phone 102, or any computer and/or communications device utilizing a digital signal processor (DSP) 104. The Internet Protocol communications devices 22 may also include addressable watches, radios, vehicles, clocks, printers, gateways, and other apparatuses and systems.

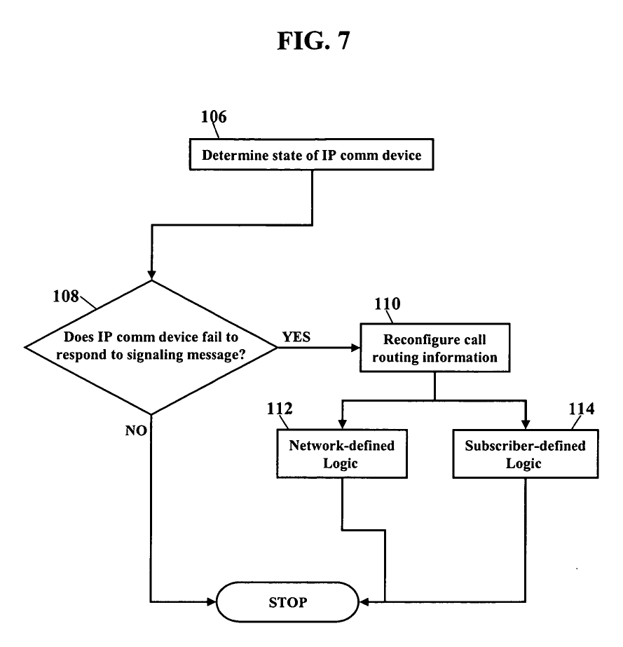

FIG. 7 is a flowchart illustrating a method of providing communications services. A state of an Internet Protocol communications device is determined (Block 106). If the Internet Protocol communications device fails to respond to a signaling message (Block 108), then reconfigure (Block 110) the call routing information based upon at least one of i) network-defined logic (Block 112) and ii) subscriber-defined logic (Block 114). The call routing information is thus reconfigured based upon the state of the Internet Protocol communications device.

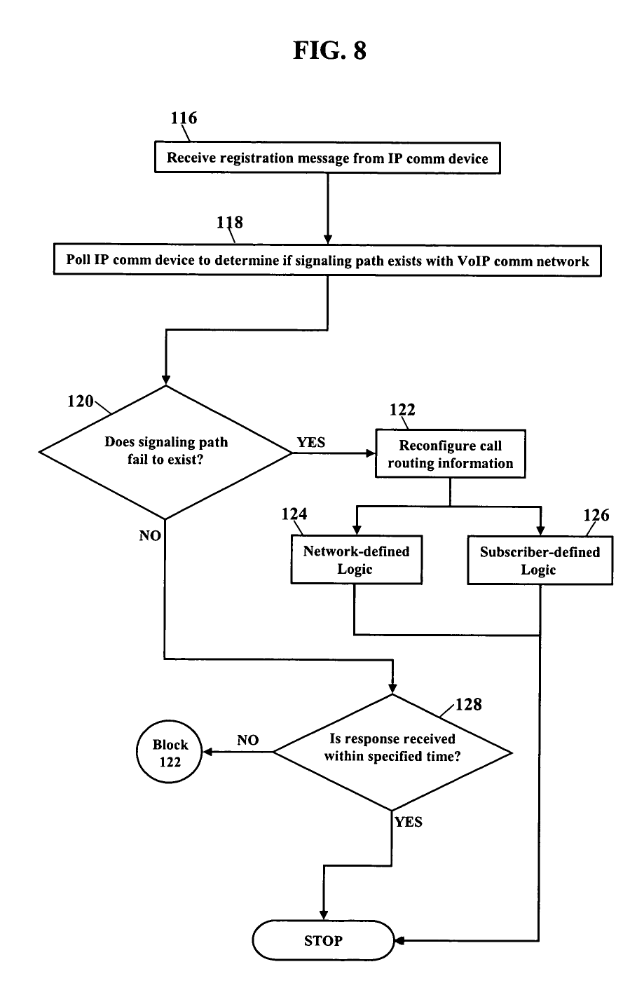

FIG. 8 is a flowchart illustrating another method of providing communications services. A registration message is received from the Internet Protocol communications device (Block 116). The Internet Protocol communications device is then polled to determine if a signaling path exists with a Voice-Over Internet Protocol communications network (Block 118). If the signaling path fails to exist (Block 120), then reconfigure (Block 122) the call routing information based upon at least one of i) network-defined logic (Block 124) and ii) subscriber-defined logic (Block 126). If the signaling path exists (Block 120), but the response is not received within a specified time (Block 128), then reconfigure (Block 122) the call routing information based upon at least one of i) the network-defined logic (Block 124) and ii) the subscriber-defined logic (Block 126). The call routing information is thus proactively reconfigured based upon an availability of the Internet Protocol communications device.

The Communications Module may be physically embodied on or in a computer-readable medium. This computer-readable medium may include CD-ROM, DVD, tape, cassette, floppy disk, memory card, and large-capacity disk (such as IOMEGA®, ZIP®, JAZZ®, and other large-capacity memory products (IOMEGA®, ZIP®, and JAZZ® are registered trademarks of Iomega Corporation, 1821 W. Iomega Way, Roy, Utah 84067, 801.332.1000, www.iomega.com). This computer-readable medium, or media, could be distributed to end-users, licensees, and assignees. These types of computer-readable media, and other types not mention here but considered within the scope of the present invention, allow the Communications Module to be easily disseminated. A computer program product for providing communications services includes the Communications Module stored on the computer-readable medium. The Communications Module determines a state of an Internet Protocol communications device and reconfigures call routing information based upon the state of the Internet Protocol communications device.

The Communications Module may also be physically embodied on or in any addressable (e.g., HTTP, I.E.E.E. 802.11, Wireless Application Protocol (WAP)) wire line or wireless device capable of presenting an IP address. Examples could include a computer, a wireless personal digital assistant (PDA), an Internet Protocol mobile phone, or a wireless pager.

While the present invention has been described with respect to various features, aspects, and embodiments, those skilled and unskilled in the art will recognize the invention is not so limited. Other variations, modifications, and alternative embodiments may be made without departing from the spirit and scope of the present invention.

1. A method of providing communications services, comprising the steps of:
determining a state of an Internet Protocol communications device; and
reconfiguring call routing information based upon the state of the Internet Protocol communications device.

2. A method according to claim 1, wherein the step of determining the state of the Internet Protocol communications device comprises determining whether the Internet Protocol communications device fails to respond to a communication.

3. A method according to claim 2, further comprising the step of:
if the Internet Protocol communications device fails to respond to the communication, then reconfiguring the call routing information based upon at least one of i) network-defined logic and ii) subscriber-defined logic.

4. A method according to claim 1, further comprising the step of reconfiguring the call routing information based upon network-defined logic.

5. A method according to claim 1, further comprising the step of reconfiguring the call routing information based upon a subscriber profile.

6. A method according to claim 1, wherein the step of determining the state of the Internet Protocol communications device comprises polling the Internet Protocol communications device.

7. A method of providing communications services, comprising the steps of:
polling an Internet Protocol communications device to determine if a signaling path exists in a Voice-Over Internet Protocol communications network; and
if the signaling path fails to exist, then reconfiguring call routing information based upon at least one of i) network-defined logic and ii) subscriber-defined logic,
wherein the call routing information is reconfigured based upon an availability of the Internet Protocol communications device.

8. A method of providing communications services, comprising the steps of:
polling an Internet Protocol communications device to determine if a signaling path exists in a Voice-Over Internet Protocol communications network; and
if a response is not received within a specified time, then reconfiguring call routing information based upon at least one of 1) the network-defined logic and ii) the subscriber-defined logic,
wherein the call routing information is reconfigured based upon an availability of the Internet Protocol communications device.

9. A system, comprising:
a Communications Module stored in a memory device, and a processor communicating with the memory device;
the Communications Module determining a state of an Internet Protocol communications device and reconfiguring call routing information based upon the state of the Internet Protocol communications device.

10. A computer program product, comprising:
a computer-readable medium; and
a Communications Module stored on the computer-readable medium, the Communications Module determining a state of an Internet Protocol communications device and reconfiguring call routing information based upon the state of the Internet Protocol communications device.
